(19) United States
(12) Patent Application Publication
(10) Pub. No.: US 2007/0278180 A1
(43) Pub. Date: Dec. 6, 2007

(54) ELECTRON INDUCED CHEMICAL ETCHING FOR MATERIALS CHARACTERIZATION

(76) Inventors: Mark J. Williamson, Boise, ID (US); Gurtej S. Sandhu, Boise, ID (US); Justin R. Arrington, Boise, ID (US); Neal R. Rueger, Boise, ID (US)

Correspondence Address: SCHWEGMAN, LUNDBERG & WOESSNER, P.A., P.O. BOX 2938, MINNEAPOLIS, MN, 55402, US

(21) Appl. No.: 11/421,711

(22) Filed: Jun. 1, 2006

(51) Int. Cl. C03C 25/68; G01L 21/30

(52) U.S. Cl. 216/58; 216/59; 216/60; 156/345.39; 156/345.4

(57) ABSTRACT

A method of imaging and identifying materials on and below the surface of a structure is described. The method may be used in areas as small as one micron in diameter, and may remove a thin portion of the topmost material, repeating the analysis, until a desired depth is obtained. An energetic beam, such as an electron beam, is directed at a selected surface location. The surface has an added layer of a solid, fluid or gaseous reactive material, such as a directed stream of a fluorocarbon, and the energetic beam disassociates the reactive material in the region of the beam into radicals that chemically attack the surface. The reaction products from the radical attack on the surface are pumped away from the surface and analyzed using various methods, such as optical emission, infrared, atomic absorption, or Raman spectroscopy.

### TECHNICAL FIELD

This application relates generally to semiconductor devices and device testing and, more particularly, to analysis of materials and objects associated with electrical function failure and long term reliability failure in integrated circuit (IC) devices on semiconductor wafers, such as memory devices, logic devices and microprocessors.

### BACKGROUND

The semiconductor device industry has a market driven need to reduce device failures at electrical test, and to improve the operational lifetimes of IC devices. Reduced device failures may result in increased IC fabrication yield and improved device operational lifetime. Increased IC fabrication yields may result in decreased IC prices, and improved market share.

One method to reduce the number of device failures is to analyze failed devices and determine the cause of the failure. It is well known to examine failed devices by means of electrical testing, optical microscopes, transmitting electron microscopes (TEM), scanning electron microscopes (SEM), and other well known methods. If, for example, a contamination particle is found that produces a short between two conductive lines in a signal layer, then action may be taken at the fabrication site to reduce particle levels, and thus increase fabrication yield. This method may be used in cases where the failure, such as the illustrative particle just discussed, is at, or near, the surface of the sample, since the failure may not be otherwise visible in an optical microscope or an electron microscope.

If the cause of the device failure is not on the surface of the sample, it is known to cut or fracture the device at a location near the suspected failure site, set the fracture surface in a holding mechanism, such as epoxy, and grind or polish the exposed lateral edge down to approximately the failure location. The location beneath the device surface may then be seen in cross section by SEM or optical microscope, and the nature of the defect may be observed.

It is known to remove the top layers of an IC device by means of what may be known as a spot etch, in which a small elastomeric ring formed of a chemically resistant material is pressed onto the surface of the IC in the area of the suspected defect and serves to hold an etching solution designed to remove some or all of the top layers of the structure and expose the defect. However, the size of the elastomeric ring is very large as compared to the dimensions of typical structures, such as ICs, and may be larger than 2 mm in diameter, and thus produces a relatively large hole in the IC device. Further, there is no method to image the surface during the material removal process to determine if the lateral positioning is correct, or to determine if the depth of the material removal has reached the desired location.

It is known to etch small diameter holes of several microns in diameter in IC surfaces by means of what may be known as ion milling, using focused ion beams of such heavy materials as gallium. It is possible to analyze the material being etched by means of examination of the atoms in the exhaust gas stream, typically using methods such as optical emission spectroscopy, atomic absorption spectroscopy, infrared spectroscopy, Raman spectroscopy, or mass spectroscopy. However, ion milling is not generally able to selectively etch certain types of materials, such as oxide over metal, with a reasonable etch ratio, as compared to the high selectivity available with the chemical spot etching discussed above, and it is difficult to determine when the vertical etch depth has reached the desired location

A method is needed to chemically etch a small area of a surface with high selectivity between different material etch rates, with the ability to observe the etching progress, as well as the ability to analyze the composition of the material being etched. With such an arrangement, the sample may be imaged during the small spot etching, and analysis of materials of interest that may appear unexpectedly during the progress of etching may be easily performed.

### BRIEF DESCRIPTION OF THE DRAWINGS

The following description of embodiments, advantages, aspects and features of the disclosure should be read with reference to the drawings.

FIG. 1 illustrates a semiconductor device having a defect;

FIG. 2 illustrates the semiconductor device of FIG. 1 in a vacuum chamber in an illustrative embodiment;

FIG. 3 illustrates the device of FIG. 2, after a period of etching has occurred in an illustrative embodiment;

FIG. 4 is a flowchart of the method in accordance with an illustrative embodiment;

FIG. 5 is a block diagram of an electronic device in accordance with an embodiment of the invention; and

FIG. 6 is a diagram of an electronic system having devices in accordance with an embodiment of the invention.

### DETAILED DESCRIPTION

The following detailed description refers to the accompanying drawings that show, by way of illustration, specific aspects and embodiments in which the present disclosure may be practiced. These embodiments are described in sufficient detail to enable those skilled in the art to practice the present disclosed methods and apparatus. Other embodiments may be utilized and structural, logical, and electrical changes may be made without departing from the scope of the present disclosure. The various embodiments are not necessarily mutually exclusive, as some embodiments can be combined with one or more other embodiments to form new embodiments.

The term “horizontal” as used in this application is defined as a plane parallel to the conventional plane or surface of a wafer or substrate, regardless of the orientation of the wafer or substrate. The term “vertical” refers to a direction perpendicular to the horizontal as defined above. Prepositions, such as “on”, “side” (as in “sidewall”), “higher”, “lower”, “over” and “under” are defined with respect to the conventional plane or surface being on the top surface of the wafer or substrate, regardless of the orientation of the wafer or substrate. The following detailed description is, therefore, not to be taken in a limiting sense, and the scope of the present disclosed embodiments of invention is defined only by the appended claims, along with the full scope of equivalents to which such claims are entitled.

The disclosure provides a method for localized accelerated chemical etching of any material, such as an integrated circuit (IC). In an embodiment, the localized accelerator is an electron beam, and the excited material is a halogen containing compound forming a layer on, or immediately above, the surface of the IC in a vacuum chamber, such as inside a scanning electron microscope (SEM). Localized electron beam assisted chemical etching provides a method of localized materials characterization, such as may be useful in IC failure analysis. This method allows for selective and/or sequential etching of various layers, and may be compared to what is known in the semiconductor art as spot etching for failure analysis and electrical characterization. It is also possible to use the described method to selectively deposit materials locally, for example in the etched hole. For example, a one micron diameter hole may be etched through several different material layers of an IC chip, and an undesired metal particle (perhaps shorting two signal lines together) may be selectively etched away. The hole may then be filled with a dielectric material using the electron beam method to create radicals of silane and oxygen to form a silicon oxide dielectric layer in the hole. The “repaired” device may then be removed from the system and electrically function tested to determine if the undesired particle was the sole cause of the observed failure.

Materials characterization may typically occur, in an illustrative embodiment, by passing a gas phase halogen containing material over the surface of the IC chip in the vacuum chamber, and exciting the halogen atoms with an electron beam to form chemical radicals. By controlling the vacuum pressure and the gas flow, the mean free diffusion length of the radicals may be controlled, and the etching of the IC surface may be confined to a desired region around the electron beam. Electrons from the primary beam, electrons scattered from the IC surface, as well as secondary electrons from the IC surface may all cause the formation of the halogen radicals by dissociating the individual atoms of the halogen containing layer. The halogen containing layer may be adsorbed onto the surface of the IC, as may occur when using a base material such as xenon difluoride, which sublimates in a vacuum and may deposit on the surface of the IC.

The radicals may selectively or non-selectively etch portions of the IC surface, depending upon the selected combination of chemicals, and the etch products may be removed from the surface of the IC by the vacuum system pump. The removed materials may then be analyzed by a variety of down stream systems, such as a residual gas analyzer (RGA), to provide the material characterization. The characterization may be done continuously until a desired depth is reached in the IC surface, or may be done at selected intervals, or when an interesting item is observed in the SEM view. This method provides a combination of chemical and spatial information as a function of depth while removing layers of the IC, which may be known as deprocessing. In addition to materials analysis, the etching method may be used to remove material in a non-functioning area of the IC to look for particles, image errors, bridging, foreign materials, or even for voids and holes. For example, it is possible to use the method to determine if copper metallization has penetrated a diffusion barrier and reached an active electron region of the device.

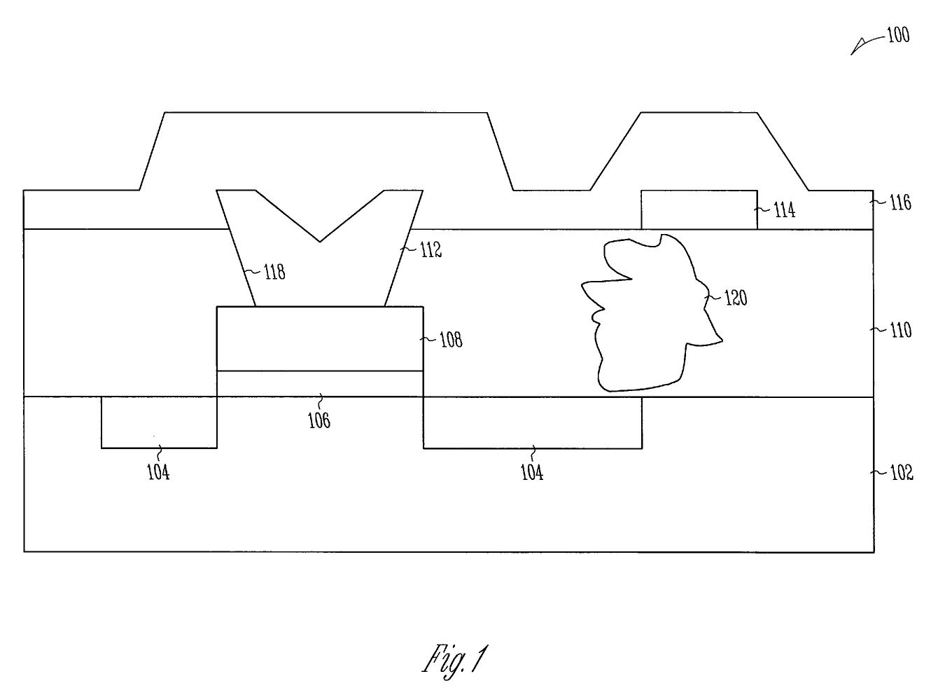

FIG. 1 illustrates a semiconductor device 100, having a substrate 102, with two diffused regions 104. The diffused regions form the source and drain of a transistor having a gate dielectric 106, and a gate electrode 108, which in combination with an electrical signal, may cause an electrically conductive channel to appear in the substrate 102 between the source and drain electrodes 104, as is typically the case in metal oxide semiconductor (MOS) transistors. The transistor controlled by the gate electrode 108, is protected from unwanted external electrical signals by the dielectric protection layer 110, which has a contact structure 118 allowing the desired electrical signal carried on conductive material 112 to access the gate electrode 108. The source and drain diffusion regions 104 will also have contact to a conductive material at some location, to provide the signal or bias required to have the transistor operate in the desired fashion. The contacts to the source and drain are not shown to simplify the figure. There are other conductive material lines such as line 114, which connect various transistors to each other and to selected input/output connections, but in this illustrative embodiment line 114 is not intended to contact any portion of the shown transistor. The conductive material lines 112 and 114 are protected from environmental problems such as scratches and ionic contamination by a dielectric layer 116.

The semiconductor device 100 is shown having a defect 120 in the dielectric layer 110, that may electrically bridge the gap between the metal conductor 114 and the source or drain 104, thus causing a potential electrical leakage path or short. The defect may be a conductive particle that fell on the device during manufacture, and caused a large enough electrical leakage path that the device failed at electrical test. Alternatively, the particle may have caused a leakage path that did not have sufficient conduction to cause an electrical failure at test, until sufficient environmental exposure provided enough ionic contamination to increase the leakage current to a failing level. In either case, characterizing the structure of the device 100 to uncover the failure mode may result in the ability to correct the failure and increase yield and device operational lifetime.

A particle or a void 120 that may cause a failure, may not be visible to an optical microscope due to the conductive line 114 above the particle 120. An examination of the device in a SEM may likewise not show the defect 120 due to the smoothing effect of the overlying layers 110, 114 and 116. Thus, it may be beneficial to etch a small hole in the dielectric layer 116 and the dielectric layer 110, without etching the metal 114, and remove at least a portion of the defect 120 (assuming the defect is a particle as in this illustrative example), and analyze the material forming the particle 120 to determine the cause of the defect.

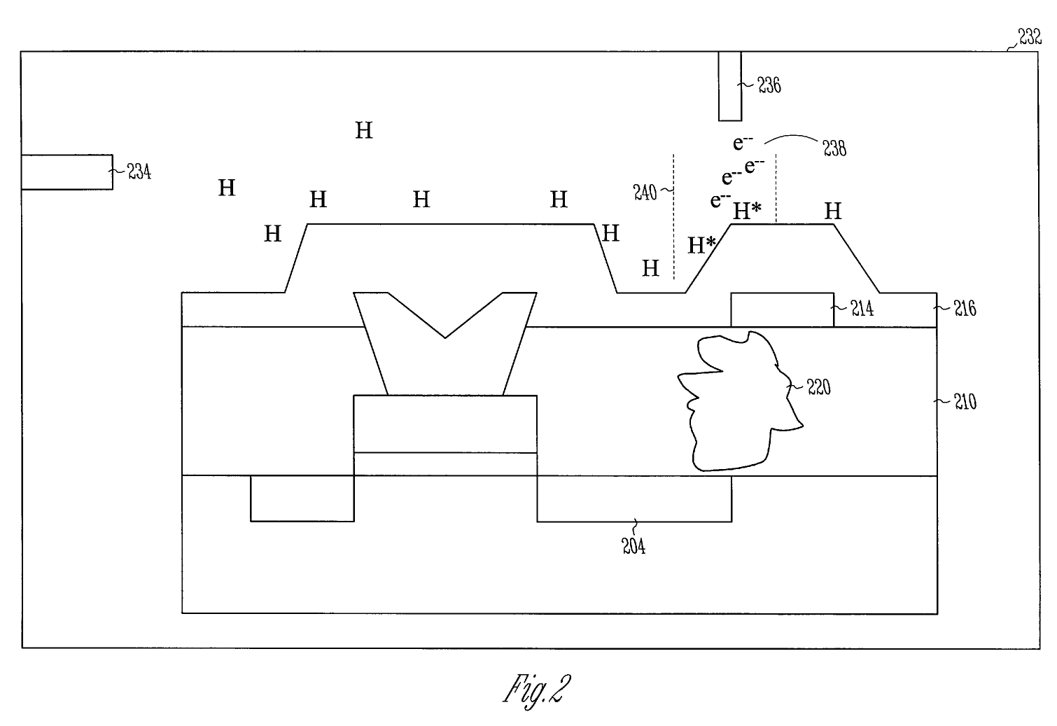

FIG. 2 illustrates the semiconductor device of FIG. 1 in a vacuum chamber 232, in an embodiment, a SEM, having a vacuum pump (not shown for simplicity), an inlet 234, and an energetic beam 236, such as an electron beam. The inlet 234 may be a directed gas jet as shown, or a sublimation port, a gas shower head, or a liquid material sprayer, such as an atomizer. The inlet 234 supplies the region around the top surface of the sample with a material that is either reactive, or may be made reactive, such as a halogen containing material. The atoms of the halogen in this illustrative example are shown as floating “H” symbols, some of which are adsorbed onto the surface of the sample, and some diffusing around the chamber 232.

The vacuum chamber 232 has a directed and focused energetic beam device 236, which in an embodiment is a SEM beam, directed to a desired location on the surface of the sample, where a failure may be believed to exist. The electron beam device 236 emits electrons 238 (shown as “e⁻” symbols) which excite the halogen molecules or atoms (H) floating in the vacuum chamber 232, or adsorbed onto the surface of the sample, and form a chemically reactive radical, denoted by “H*”, which due to the limited lifetime of radicals, are limited to the area around the electron beam 236 shown by the dotted lines 240. The selected radicals H* have a much greater chemical etch rate on the dielectric layer 216, and on the dielectric layer 210, than the halogen molecules or atoms (H). In an illustrative embodiment, the halogen compound is xenon difluoride, which forms fluorine radicals when excited by the electron beam. The fluorine radicals have a large etch rate on the dielectric layers 216 and 210, but do not rapidly etch conductive materials such as 214, which may for example be formed of aluminum, or the particle 220. In this example, the etching is said to be selective for dielectrics over conductive materials.

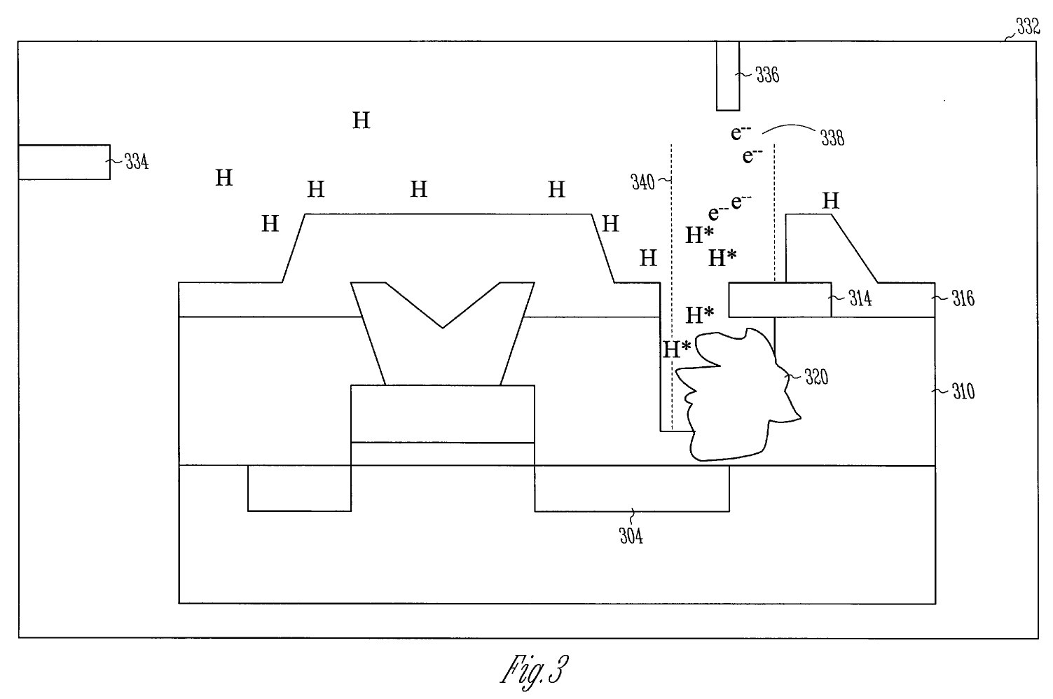

FIG. 3 illustrates the situation of FIG. 2, after a period of etching of the dielectric layers has passed. The material being removed, which may include portions of the particle 320, may be analyzed by any of the down stream methods previously discussed, such as RGA. In addition, the particle 320 may be examined directly using SEM based analysis system such as EDAX, X-ray analysis or secondary electron emission analysis methods. The particle 320 may be thus identified and characterized for composition, which may suggest the cause of the defect and methods to reduce the problem.

It may be seen that the conductive line 314 has been undercut in this illustrative embodiment, and that the particle 320 has been reduced in size due to the slow etching of the selected halogen fluorine radicals on conductive materials, which as noted above have a selectivity to rapidly etch dielectric materials, such as layers 310 and 316. The reactive material injected into the chamber 332 by the inlet 334, may be changed at this point in the etch process to a material having an etch selectivity to the suspected or determined particle material. For example, the particle might be a metal flake or a photolithography defect, and thus rapidly etch in a chlorine radical atmosphere as compared to the fluorine radical atmosphere of the dielectric etch just discussed. In this fashion the particle may be partially or completely removed, and chlorine etch may increase the number of particle atoms available for downstream analysis, thus increasing the sensitivity of the method.

In an embodiment, the particle is removed, and the material injected into the vacuum chamber 332 is changed to include a dielectric deposition gas mixture, such as silane and oxygen, which may react rapidly in the presence of the electron beam from device 336, and preferentially grow a dielectric layer in the hole under the conductor 314. The repaired device may be removed from the vacuum chamber 332, and electrically function tested in any common method, to determine if the particle 320 was the only failure in the device, or the device may be operated.

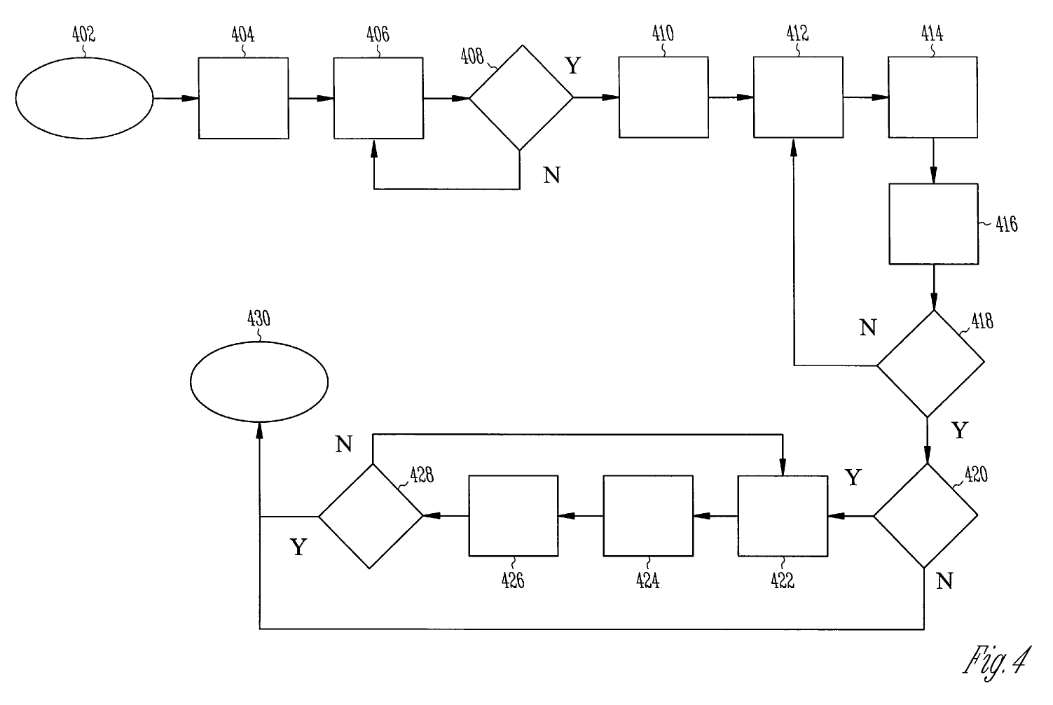

FIG. 4 is a flow diagram showing the method for electron induced chemical etching for materials characterization. The method starts at 402 with obtaining a sample, such as a defective IC, for characterization. At 404 the sample is placed in a vacuum chamber, such as a SEM, and the chamber begins to be evacuated at 406. At 408 it is decided whether or not the chamber has been pumped to a desired vacuum pressure, which may be used to control the mean free path of the radicals generated by the electron beam. If the desired pressure is not yet obtained, the method returns to 406. When the proper vacuum level is reached the method uses a beam locator device, such as a SEM, to find the desired location at 410. At 412 the reactive material is injected into the vacuum chamber at a controlled rate, which in conjunction with the control of the vacuum pressure and the beam energy and intensity, may determine the production rate of the chemical radicals. The electron beam is turned on at a desired energy and beam intensity at 414, which depending upon the selected reactive material composition and pressure begins the chemical etching of at least some portion of the sample surface towards which the electron beam is directed. The reaction products are removed by the vacuum system.

At 416, the reaction products are analyzed by any of a variety of down stream analytic methods, such as RGA. The surface may also be directly examined during this step by imaging the etch region with a SEM, and the surface may be analyzed by SEM based analysis methods, such as EDAX or XES. The observation of the surface and the growing etch pit may occur during any of the steps. At 418 it is determined whether the current material has been etched sufficiently, or whether the defect has been identified and characterized. If not the method returns to 412 until the current layer has been etched to a desired depth.

If the current layer etching and analysis has been completed, then it is determined at 420 if there is an additional layer that needs to be etched, or whether there is to be a localized deposition done to fill the etched hole. If not, the method ends at 430.

If there is another process to complete prior to ending the method, then a new reactive material may be injected into the vacuum chamber at 422, the electron beam is turned on to the desired energy level and intensity at 424, the etching maybe observed and the surface analyzed, and the etch product is analyzed by a downstream analysis method at 426. At 428, it is determined if the present layer has been fully characterized. If not the method returns to 422. If the layer etch is completed, the method ends at 430. Clearly, the method to be used if there is a third layer to etch or fill, is a repetition of the steps from 422 to 428, until all the desired layers are analyzed, etched or filled.

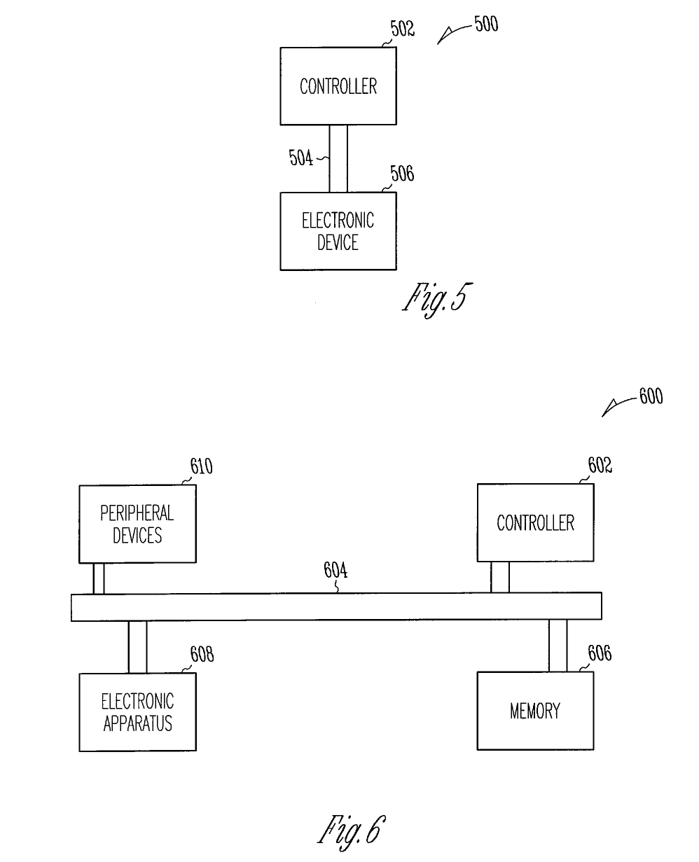

FIG. 5 is a block diagram of a general electronic device in accordance with an embodiment of the invention with an electronic system 500 having one or more devices failure analyzed and tested and/or repaired according to various embodiments of the present invention. Electronic system 500 includes a controller 502, a bus 504, and an electronic device 506, where bus 504 provides electrical conductivity between controller 502 and electronic device 506. In various embodiments, controller 502 and/or electronic device 506 include an embodiment for a portion of the device having an IC die characterized and/or repaired as previously discussed herein. Electronic system 500 may include, but is not limited to, information handling devices, wireless systems, telecommunication systems, fiber optic systems, electro-optic systems, and computers.

FIG. 6 depicts a diagram of an embodiment of a system 600 having a controller 602 and a memory 606. Controller 602 and/or memory 606 include a portion of the circuit having IC devices and memory chips characterized and/or repaired in accordance with the disclosed embodiments. System 600 also includes an electronic apparatus 608, and a bus 604, where bus 604 may provide electrical conductivity and data transmission between controller 602 and electronic apparatus 608, and between controller 602 and memory 606. Bus 604 may include an address, a data bus, and a control bus, each independently configured. Bus 604 also uses common conductive lines for providing address, data, and/or control, the use of which may be regulated by controller 602. In an embodiment, electronic apparatus 608 includes additional memory devices configured similarly to memory 606. An embodiment includes an additional peripheral device or devices 610 coupled to bus 604. In an embodiment controller 602 is a processor. Any of controller 602, memory 606, bus 604, electronic apparatus 608, and peripheral device or devices 610 may include ICs treated in accordance with the disclosed embodiments. System 600 may include, but is not limited to, information handling devices, telecommunication systems, and computers. Peripheral devices 610 may include displays, additional memory, or other control devices operating with controller 602 and/or memory 606.

### CONCLUSION

A method is presented of characterizing a material by positioning the material in a vacuum chamber, and creating a layer of a reactive material in proximity with the surface of the structure. Exciting the layer of reactive material forms chemical radicals, which remove a portion of the surface of the material by chemical etching. The material removed from the surface may be analyzed to characterize the material in various ways, and this removing and analyzing continues until a stop criterion occurs. With such an arrangement, the various types of material in a structure, such as an IC chip, may be determined, both at the surface, and at various depths.

Typically, the reactive material comprises a halogen in gaseous, liquid or solid form. In an embodiment, the reactive material is xenon fluoride, which is a solid at standard temperature and pressure, and sublimes in the vacuum chamber. The reactive material may be directed to the region near the surface of the IC chip by a formed jet of vapor, or may simply be allowed to diffuse through the vacuum chamber. The reactive material may be adsorbed onto the surface of the material, may be a gas in the vicinity of the surface, or may condense or precipitate onto the surface. The reactive material may be a mixture of materials (that is chemical precursors) which react with one another, especially when activated or excited to form chemical radicals, and may include a material that does not directly interact with the other reactive materials, but rather acts as a reaction catalyst, an inhibitor, promoter, or reaction buffer. The chemical radicals may form a chemical etching environment that may selectively remove one component of the material to be characterized, and the precursor reactive materials may be changed as the process continues and as different materials are uncovered on the IC.

The method of exciting the layer of reactive materials may use an energetic beam such as an electron beam. The electron beam may have a diameter of less than 0.1μ, or less than 0.01μ, or greater than 1.0μ, depending upon the size of the area that is to be analyzed. The electron beam may have a lower energy to slow the etch rate to a rate easier to control, or may be defocused to etch a wider area as the circumstances require. If the energy density of the electron beam is not sufficient when defocused to create enough chemical radicals, then the electron beam may be scanned to cover the desired etch area and etch shape. The etch areas may be made as small as the electron beam can be focused, plus the mean free path of the generated chemical radicals, and may be less than a diameter of 1.0μ. The electron beam may be part of a scanning electron microscope (SEM), and the SEM may be used to provide an image of the process as etching occurs.

The surface material removed by the chemical radicals is analyzed by any well known analytical method, including downstream analysis systems such as residual gas analyzer (RGA), mass spectroscopy (quadra-pole or magnetic), optical emission spectroscopy, atomic absorption spectroscopy, infrared spectroscopy, Raman spectroscopy, and direct spot analysis of the surface by energy dispersive analysis of X-rays (EDAX), XES, or other SEM based analytic methods. This analysis may continue while the etch process is occurring to provide a material characterization versus depth analysis.

Another illustrative embodiment of the invention includes a system for localized accelerated chemical etching, including a vacuum chamber and a fixture for positioning a sample, a system, such as a gas inlet jet, for creating a layer of a chemical proximate to the surface of the sample. An energetic beam, such as an electron beam from a SEM, is directed at the surface of the sample to form chemical radicals in the chemical, such as xenon difluoride, which etch the sample in the region around the site of the energetic beam. The removed material may be analyzed to determine both the composition of the surface of the sample, and progressively further down as etching continues to a desired depth. The depth may be observed during the etch process by the SEM or other imaging device, and the composition of contaminants, such as particles, may be determined by the analysis device. Areas smaller than one micron in diameter may be etched to any desired depth, with full surface and down stream analysis capability.

The described embodiments are directed towards the use of an electron beam to activate an adsorbed material forming a layer on an IC chip, and forming chemical radicals to etch the surface material of the IC, but embodiments of the invention are not so limited, and may be applied to other structures and devices, such as printed circuit boards (PCBs), multi-chip modules (MCMs), liquid crystal display (LCD) devices, electronic displays, micro-electromechanical devices (MEMs), or other manufactured electronic or mechanical devices requiring failure analysis testing and material identification. Other means of forming local chemical radicals other than electron beams are included in this disclosure, to include focused microwave beams, laser and maser beams, X-ray and other energetic radiation sources. The material used to form the chemical radicals may be a gas, an evaporated liquid, a sublimed solid, or may be chemically formed by mixing precursor materials at the surface of the structure to be analyzed, or mixed remotely from the surface and either passively or actively transported to the region around the surface of the IC, or other structure. The reactive material may be either adsorbed onto the surface, precipitated onto the surface, or form a fluid layer in proximity to the surface, including a gaseous layer in the region around the IC surface. The generated chemical radicals may be used to selectively etch the surface as described in the described embodiments, or may react with other provided, or already present materials, to form dielectric, conductive or other materials to become a local deposition reaction. Such depositions may be used for example, to repair an open circuit in a conductive line, to add dielectric material to a void defect, or to program a circuit by blowing fuses or connecting conductive lines, as well as refilling the previously etched region to return the IC or other structure to a working condition.

Although specific embodiments have been illustrated and described herein, it will be appreciated by those of ordinary skill in the art that any arrangement that is calculated to achieve the same purpose may be substituted for the specific embodiments disclosed, described and shown. This application is intended to cover any adaptations or variations of embodiments of the present invention. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon studying the above description. The scope of the present invention embodiments include any other applications in which combinations and variations of the above structures and fabrication methods are used. The scope of the embodiments of the present invention should be determined with reference to the appended claims, along with the full scope of equivalents to which such claims are entitled.

What is claimed is:

1. A method of characterizing a material, comprising:
positioning a structure containing the material to be characterized in a vacuum chamber;
creating a layer of a reactive material in proximity with a surface of the structure;
exciting the layer of reactive material to form chemical radicals;
removing a portion of the surface of the material;
analyzing the material removed from the surface; and
continuing until a stop criterion occurs.

2. The method of claim 1, wherein the reactive material comprises a halogen.

3. The method of claim 1, wherein the reactive material is a gas.

4. The method of claim 2, wherein the reactive material is xenon fluoride.

5. The method of claim 1, wherein the reactive material is a mixture of materials capable of reacting with one another.

6. The method of claim 5, wherein the mixture of reactive materials includes at least one material that does not directly interact with the other reactive materials.

7. The method of claim 1, wherein exciting the layer of reactive materials comprises an electron beam.

8. The method of claim 7, wherein the electron beam has a diameter of less than 0.1∥.

9. The method of claim 8, wherein an area containing the chemical radicals has a diameter of less than 1.0μ.

10. The method of claim 9, wherein the radicals comprise a chemical etching environment disposed to remove at least one component of the material to be characterized.

11. The method of claim 10, wherein the reactive material is changed as the chemical etching occurs to selectively remove different components of the material to be characterized.

12. The method of claim 7, wherein the electron beam comprises a portion of a scanning electron microscope.

13. The method of claim 12, wherein the scanning electron microscope is disposed to provide an image of the portion of the surface of the material to be removed.

14. The method of claim 13, wherein the scanning electron microscope provides the image during the removing a portion of the surface of the material.

15. The method of claim 1, wherein the portion of the surface of the material removed by the chemical radicals is analyzed by at least one of residual gas analyzer, mass spectroscopy, optical emission spectroscopy, atomic absorption spectroscopy, infrared spectroscopy, Raman spectroscopy and energy dispersive analysis of X-rays.

16. The method of claim 15, wherein the material analysis continues as the chemical radicals etch into the surface of the material to produce a material characterization versus depth analysis.

17. The method of claim 1, wherein the stop criteria include identifying a specified material, identifying an unexpected material, reaching a specified depth below the surface of the material to be characterized, and imaging a defect.

18. The method of claim 1, wherein a vacuum pressure of the vacuum chamber is determined by a desired mean free path of the chemical radicals generated by the exciting the layer of reactive material.

19. The method of claim 1, wherein the reactive material is adsorbed onto the surface of the material to be characterized.

20. The method of claim 18, wherein the reactive material is a solid at standard temperature and pressure, and sublimes in the vacuum chamber at the determined vacuum pressure.

21. A method of materials characterization, comprising:
positioning an integrated circuit to be characterized in a vacuum chamber;
creating a layer of a halogen material proximate to a surface of the integrated circuit;
directing an electron beam to a selected location of the layer of reactive material to form halogen radicals;
chemically etching the surface of the integrated circuit proximate to the location of the electron beam; and
removing and analyzing etch products formed by the etching.

22. The method of claim 21, wherein the halogen comprises a fluorine containing compound.

23. The method of claim 22, wherein the halogen is xenon fluoride.

24. The method of claim 21, wherein the halogen is a gas.

25. The method of claim 21, wherein the electron beam has a diameter of less than 0.1μ.

26. The method of claim 21, wherein an area containing the halogen radicals has a diameter of less than 1.0μ.

27. The method of claim 21, wherein the halogen material is changed as the chemical etching occurs to selectively remove different components of the integrated circuit to be characterized.

28. The method of claim 21, wherein the electron beam comprises a portion of a scanning electron microscope disposed to provide an image of the region being chemically etched.

29. The method of claim 21, wherein analyzing the etch products includes at least one of residual gas analyzer, mass spectroscopy, optical emission spectroscopy, atomic absorption spectroscopy, infrared spectroscopy, Raman spectroscopy and energy dispersive analysis of X-rays.

30. The method of claim 21, wherein the analyzing of etch products continues as the halogen radicals etch into the surface of the material to produce a material characterization versus depth analysis.

31. A system for localized accelerated chemical etching, comprising:
a vacuum chamber including a fixture for positioning a sample;
a gas jet for creating a layer of a selected chemical combination in proximity with a surface of the sample;
an energetic beam directed at a selected location on the surface of the sample to form chemical radicals; and
an analysis device for examining material removed from the vacuum chamber and the surface of the sample.

32. The system of claim 31, wherein the energetic beam is an electron beam.

33. The system of claim 32, wherein the electron beam is a portion of a scanning electron microscope.

34. The system of claim 33, wherein the electron microscope is disposed to provide images of the localized etch area during the formation of chemical radicals.

35. The system of claim 31, wherein the selected chemical combination comprises a halogen containing compound.

36. A system for localized accelerated chemical etching, comprising:
a vacuum chamber including a fixture for positioning a sample;
means for creating a layer of a selected chemical combination in proximity with a surface of the sample;
an electron beam directed at a selected location on the surface of the sample to form chemical radicals; and
an analysis device for examining material removed from the vacuum chamber and the surface of the sample.

37. The system of claim 36, wherein the electron beam has an adjustable diameter.

38. The system of claim 37, wherein the electron beam is a portion of a scanning electron microscope.

39. The system of claim 36, wherein the selected chemical combination comprises a halogen containing compound.

40. The system of claim 36, wherein the means for creating a layer of a selected chemical combination in proximity with the surface of the sample includes a directed gas inlet, a gaseous diffusion head, a sublimation device, a bubbler and a liquid spray device.

41. A system for electron beam accelerated chemical etching, comprising:
a fixture for positioning a sample in a vacuum chamber;
means for creating a layer of a selected chemical combination in proximity with a surface of the sample;
an electron beam directed at a selected location on the surface of the sample to form chemical radicals; and
an analysis device for examining material removed from the surface of the sample.

42. The system of claim 41, wherein the electron beam and the vacuum chamber are a portion of a scanning electron microscope.

43. The system of claim 42, wherein the electron microscope provides images of the electron beam area during at least one of the formation of chemical radicals, an etching process, and a deposition process.

44. The system of claim 41, wherein the selected chemical combination comprises a halogen containing compound.

45. The system of claim 41, wherein the means for creating a layer of a selected chemical combination in proximity with the surface of the sample includes a directed gas inlet, a gaseous diffusion head, a sublimation device, a bubbler and a liquid spray device.

46. The system of claim 45, wherein the selected chemical combination includes xenon difluoride.

47. The system of claim 41, wherein the electron beam is disposed to scan an area having a predetermined shape with a beam diameter that is at least ten times less than a minimum dimension of the area.

48. The system of claim 47, wherein the predetermined shape includes at least one of a square, a rectangle, a hexagon, a conic section, a comb and a geometric shape.
